(19) United States
(12) Patent Application Publication
(10) Pub. No.: US 2024/0029148 A1
(43) Pub. Date: Jan. 25, 2024

(54) SYSTEMS AND METHODS FOR VISUALIZING PRODUCTS IN A USER'S SPACE

(71) Applicant: Wayfair LLC, Boston, MA (US)

(72) Inventors: Rachana Sreedhar, Boston, MA (US); Niveditha Samudrala, Toronto (CA); Nicole Allison Tan, Brookline, MA (US); Shrenik Sadalgi, Cambridge, MA (US)

(73) Assignee: Wayfair LLC, Boston, MA (US)

(21) Appl. No.: 18/223,847

(22) Filed: Jul. 19, 2023

Related U.S. Application Data
(60) Provisional application No. 63/390,867, filed on Jul. 20, 2022.

(51) Int. Cl. G06Q 30/0601; G06T 11/00; G06V 20/20; H04N 23/60

(52) U.S. Cl. CPC G06Q 30/0643; G06T 11/00; G06V 20/20; H04N 23/64

(57) ABSTRACT

Techniques for generating product images in a user's space. The techniques include: receiving, by a mobile device having a camera, information indicating a position in the user's space at which to place a proxy product model serving as a proxy for a product of a first type; generating, using augmented reality (AR), a visualization of the proxy product model, at the indicated position, in the user's space; receiving information indicating dimensions for the proxy product model; guiding, using AR, the user to capture one or more images of the user's space, with the mobile device, at one or more respective camera positions and/or orientations relative to the indicated position, in the user's space; obtaining, based on the information indicating the dimensions for the proxy product model and the one or more images of the user's space, at least one image of at least one product of the first type in the user's space; and displaying the at least one image of the at least one product.

### RELATED APPLICATIONS

This application claims priority under 35 U.S.C. § 119(e) to U.S. Provisional Application 63/390,867, entitled, “SYSTEMS AND METHODS FOR VISUALIZING PRODUCTS IN A USER'S SPACE,” filed Jul. 20, 2022, the entire contents of which is incorporated herein.

### BACKGROUND

One way that businesses inform consumers about their products is by showing images and/or computer-generated models of the products to the consumers. For example, an e-commerce business may display images of its products and/or computer-generated (e.g., 2D or 3D) product models on a webpage and/or any other software interface. Consumers may view such images through the webpage and/or software interfaces on their computing devices (e.g., smartphones, tablets, laptops, computers, etc.) and make purchasing decisions based on what they see. In many cases, consumers decide to purchase a product largely based on one or more images and/or one or more computer-generated models of the product, without physically viewing the product. For example, an online furniture retailer may not have any brick and mortar retail locations where customers can view furniture offerings. Thus, a customer may purchase furniture from the online furniture retailer based on the images and/or models of furniture provided by the online furniture retailer (e.g., via a website or mobile software application).

For certain types of products visualizing how a product would look in a user's environment can help the customer decide whether to purchase the product. For example, in order to make a purchasing decision, a customer may wish to visualize how an article of furniture, an appliance, a rug, art or any other item to be used in a customer's home would look in the customer's home. To this end, some e-commerce businesses have started to provide augmented reality (AR) and/or virtual reality (VR) interfaces for their customers so that the customers can visualize products in their spaces using such interfaces. For example, prior to purchasing an article of furniture, a user may wish to see how the article of furniture would appear in their home using an AR interface (e.g., on their smartphone or tablet).

### SUMMARY

Some embodiments provide for a method for generating product images in a user's space. The method comprises using at least one computer hardware processor to perform: receiving, by a mobile device having a camera, information indicating a position in the user's space at which to place a proxy product model serving as a proxy for a product of a first type; generating, using augmented reality (AR), a visualization of the proxy product model, at the indicated position, in the user's space; receiving information indicating dimensions for the proxy product model; guiding, using AR, the user to capture one or more images of the user's space, with the mobile device, at one or more respective camera positions and/or orientations relative to the indicated position, in the user's space; obtaining, based on the information indicating the dimensions for the proxy product model and the one or more images of the user's space, at least one image of at least one product of the first type in the user's space; and displaying the at least one image of the at least one product.

Some embodiments provide for a mobile device, comprising: at least one camera; at least one computer hardware processor; and at least one non-transitory computer-readable storage medium storing processor-executable instructions that, when executed by the at least one computer hardware processor, cause the at least one computer hardware processor to perform a method for generating product images in a user's space. The method comprises: receiving, by a mobile device having a camera, information indicating a position in the user's space at which to place a proxy product model serving as a proxy for a product of a first type; generating, using augmented reality (AR), a visualization of the proxy product model, at the indicated position, in the user's space; receiving information indicating dimensions for the proxy product model; guiding, using AR, the user to capture one or more images of the user's space, with the mobile device, at one or more respective camera positions and/or orientations relative to the indicated position, in the user's space; obtaining, based on the information indicating the dimensions for the proxy product model and the one or more images of the user's space, at least one image of at least one product of the first type in the user's space; and displaying the at least one image of the at least one product.

Some embodiments provide for at least one non-transitory computer-readable storage medium storing processor-executable instructions that, when executed by at least one computer hardware processor of a mobile device, cause the at least one computer hardware processor to perform a method for generating product images in a user's space. The method comprises: receiving, by a mobile device having a camera, information indicating a position in the user's space at which to place a proxy product model serving as a proxy for a product of a first type; generating, using augmented reality (AR), a visualization of the proxy product model, at the indicated position, in the user's space; receiving information indicating dimensions for the proxy product model; guiding, using AR, the user to capture one or more images of the user's space, with the mobile device, at one or more respective camera positions and/or orientations relative to the indicated position, in the user's space; obtaining, based on the information indicating the dimensions for the proxy product model and the one or more images of the user's space, at least one image of at least one product of the first type in the user's space; and displaying the at least one image of the at least one product.

Some embodiments provide for a method for generating product images in a user's space. The method comprises using at least one computer hardware processor to perform: receiving, from a mobile device and via at least one communication network, information indicating a position in the user's space at which a proxy product model was placed by a user of the mobile device, wherein the proxy product model is a proxy for a product of a first type; information indicating dimensions for the proxy product model, and one or more images of the user's space; identifying a plurality of candidate product images, the identifying comprising searching a catalog of images of products of the first type to identify images of products whose dimensions are compatible with the dimensions for the proxy product model and which were taken from camera orientations compatible with camera orientations used to capture the one or more images of the user's space; generating one or more product images by compositing one or more of the plurality of candidate images with at least one of the one or more images of the user's space; and transmitting, to the mobile device and via the at least one communication network, the one or more product images.

Some embodiments provide for at least one computer comprising: at least one computer hardware processor; and at least one non-transitory computer-readable storage medium storing processor executable instructions that, when executed by the at least one computer hardware processor, cause the at least one computer hardware processor to perform a method for generating product images in a user's space. The method comprises: receiving, from a mobile device and via at least one communication network, information indicating a position in the user's space at which a proxy product model was placed by a user of the mobile device, wherein the proxy product model is a proxy for a product of a first type; information indicating dimensions for the proxy product model, and one or more images of the user's space; identifying a plurality of candidate product images, the identifying comprising searching a catalog of images of products of the first type to identify images of products whose dimensions are compatible with the dimensions for the proxy product model and which were taken from camera orientations compatible with camera orientations used to capture the one or more images of the user's space; generating one or more product images by compositing one or more of the plurality of candidate images with at least one of the one or more images of the user's space; and transmitting, to the mobile device and via the at least one communication network, the one or more product images.

Some embodiments provide for at least one non-transitory computer-readable storage medium storing processor executable instructions that, when executed by at least one computer hardware processor, cause the at least one computer hardware processor to perform a method for generating product images in a user's space, the method comprising: receiving, from a mobile device and via at least one communication network, information indicating a position in the user's space at which a proxy product model was placed by a user of the mobile device, wherein the proxy product model is a proxy for a product of a first type; information indicating dimensions for the proxy product model, and one or more images of the user's space; identifying a plurality of candidate product images, the identifying comprising searching a catalog of images of products of the first type to identify images of products whose dimensions are compatible with the dimensions for the proxy product model and which were taken from camera orientations compatible with camera orientations used to capture the one or more images of the user's space; generating one or more product images by compositing one or more of the plurality of candidate images with at least one of the one or more images of the user's space; and transmitting, to the mobile device and via the at least one communication network, the one or more product images.

### BRIEF DESCRIPTION OF DRAWINGS

Various aspects and embodiments will be described herein with reference to the following figures. It should be appreciated that the figures are not necessarily drawn to scale. Items appearing in multiple figures are indicated by the same or similar reference number in all the figures in which they appear.

FIG. 1 is a block diagram of an example system in which some embodiments of the technology described herein may be implemented.

FIG. 2 illustrates an example interaction among the entities shown in FIG. 1, according to some embodiments of the technology described herein.

FIG. 3 is a flowchart of an example process 300 for generating product images in a user's space, according to some embodiments of the technology described herein.

FIG. 4 is a flowchart of an example process 400 for generating product images in a user's space, according to some embodiments of the technology described herein.

FIGS. 5A-5L are screenshots of a user indicating, using AR, a position in a user's space at which to place a proxy product model and providing dimensions for the proxy product model, according to some embodiments of the technology described herein.

FIGS. 6A-6G are screenshots of a user being guided, using AR, to capture image(s) of the proxy product model and/or user's space, according to some embodiments of the technology described herein.

FIGS. 7A-7B are screenshots of example webpages comprising a number of product images that may be displayed to the user in a “gallery” format, according to some embodiments of the technology described herein.

FIGS. 8A-8C illustrate example zone labels assigned to shot angles at which images of a product may be taken, according to some embodiments of the technology described herein.

FIG. 9 is a block diagram of an example computer system, according to some embodiments of the technology described herein.

FIGS. 10A-10D illustrate an overview of processing performed on product silo or lifestyle images, according to some embodiments of the technology described herein.

FIGS. 11A-11C illustrate a sample of candidate product images, according to some embodiments of the technology described herein.

FIG. 12 illustrates an overview of an AR guided capture of a user's space, according to some embodiments of the technology described herein.

FIG. 13 illustrates an overview of a guided capture of three angles of a proxy product model, according to some embodiments of the technology described herein.

FIG. 14 illustrates an example shot angle geometry, according to some embodiments of the technology described herein.

FIG. 15 illustrates an example architecture of a model used for shot angle prediction, according to some embodiments of the technology described herein.

### DETAILED DESCRIPTION

As described above, retailers may use augmented reality (AR) to improve the shopping experience for their customers. When a customer shops for products using an Internet website or a mobile device application, the customer may wish to visualize the product placed in a physical scene (e.g., in their home, office, car, etc.). To provide a visualization of the product in the physical scene, the retailer may use an AR system that allows the customer to place a virtual product model in an AR scene generated from the physical scene.

A conventional approach to using augmented reality interfaces to facilitate shopping involve: (1) generating a high-fidelity three-dimensional (3D) model of a product; (2) providing the 3D model of the product to a user's device; and (3) providing the user with an AR-enabled software application, to be installed on the user's mobile device, that allows the user to generate composite images by superimposing the 3D model of the product onto images of their physical space obtained by the camera of the user's device (e.g., the user's smart phone). The user may use the AR-enabled software application to place the 3D model in different locations in the user's environment (e.g., different rooms) and/or view the 3D model from different angles. This allows the customer to visualize what the product would look like in their physical space. The AR-enabled software application further enables the user to purchase a product if the user is so inclined.

The inventors have recognized that although such conventional AR systems are valuable, they nevertheless have drawbacks. First, a user has to manually select the product of interest prior to downloading a corresponding 3D model and visualizing it in their space. This can be a tedious, time-consuming process involving significant manual effort by the user, as the retailer may offer hundreds or thousands of products in any particular category (e.g., accent chairs, sofas, beds, rugs, art, appliances, etc.). Second, while high-fidelity 3D product models help to generate a faithful and high-quality visualization of a product, generating and rendering such models is resource intensive. For example, generating a high-fidelity 3D model of a product involves capturing numerous images of the product from a diverse and wide range of angles and processing the captured images with 3D rendering software to generate the 3D model. This is time-consuming (e.g., product manufacturers and/or resellers have to capture many product images) and computationally burdensome (e.g., the 3D rendering software uses substantial computing resources). Moreover, a user's device (e.g., a smartphone) would then have to expend resources (e.g., processor, memory, network bandwidth, etc.) to download and render such models. Third, with a conventional AR-enabled system, users may select products that do not fit in their physical space (e.g., the dimensions of the product selected may exceed the space available for the product in a user's room).

To address the above-described shortcomings of conventional AR systems, the inventors have developed new AR techniques for visualizing products of a retailer's product catalog in the context of a customer's space. Notably, the techniques developed by the inventors neither require nor use 3D product models; instead, a small set of 2D product images taken from a fixed number of predetermined angles is used to provide a high-quality AR shopping experience. As a result, the new AR techniques are less computationally demanding than conventional methods.

In addition, unlike conventional methods, the AR system developed by the inventors accounts for dimensions of a user's space by enabling the user to easily define the space allotted to products using AR (e.g., via an AR interface of a software program executing on a user's device). Using the dimensions so specified, the system filters the retailer's product catalog to identify products whose dimensions are compatible with the dimensions of the space. For example, products that physically fit in the space may be identified. The AR system may appropriately scale candidate images of the identified products, generate product images by compositing the candidate images with the images of user's space, and present the generated product images to the customer (e.g., in a non-AR interface, such as a webpage).

Accordingly, in some embodiments, a user's mobile device having a camera (e.g., a smartphone, tablet, laptop, etc.) may execute an AR-enabled software application (e.g., an app provided by the retailer) to enable the techniques described herein. With such a software application, the mobile device may: (1) receive information indicating a position in the user's space at which to place a proxy product model serving as a proxy for a product (e.g., an article of furniture) of a first type (e.g., accent chair, sofa, table, rug, lamp, etc.); (2) generate, using AR, a visualization of the proxy product model, at the indicated position, in the user's space; (3) receive information indicating dimensions for the proxy product model (e.g., width, height, and/or depth of a bounding box bounding the proxy product model); (4) guide, using AR (e.g., via an AR interface of the AR-enabled software application), the user to capture one or more images of the user's space, with the camera of the mobile device, at one or more respective camera positions and/or orientations relative to the indicated position, in the user's space; (5) obtain, based on the information indicating the dimensions for the proxy product model and the one or more images of the user's space, at least one image of at least one product of the first type in the user's space (e.g., obtain the at least one image from a product catalog); and (6) display the at least one image (e.g., a gallery of images) of the at least one product to provide a visualization of the product.

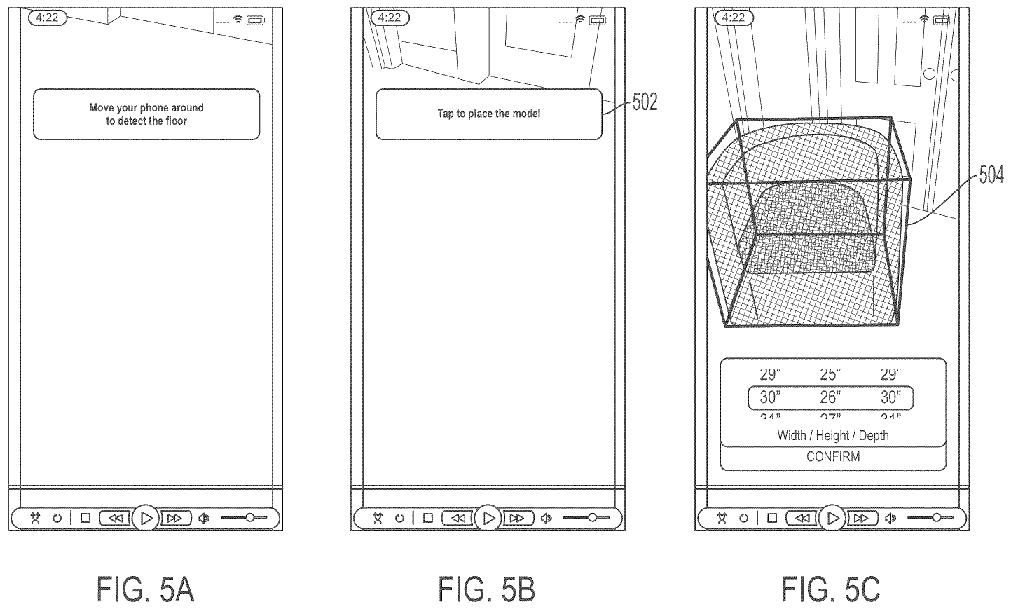

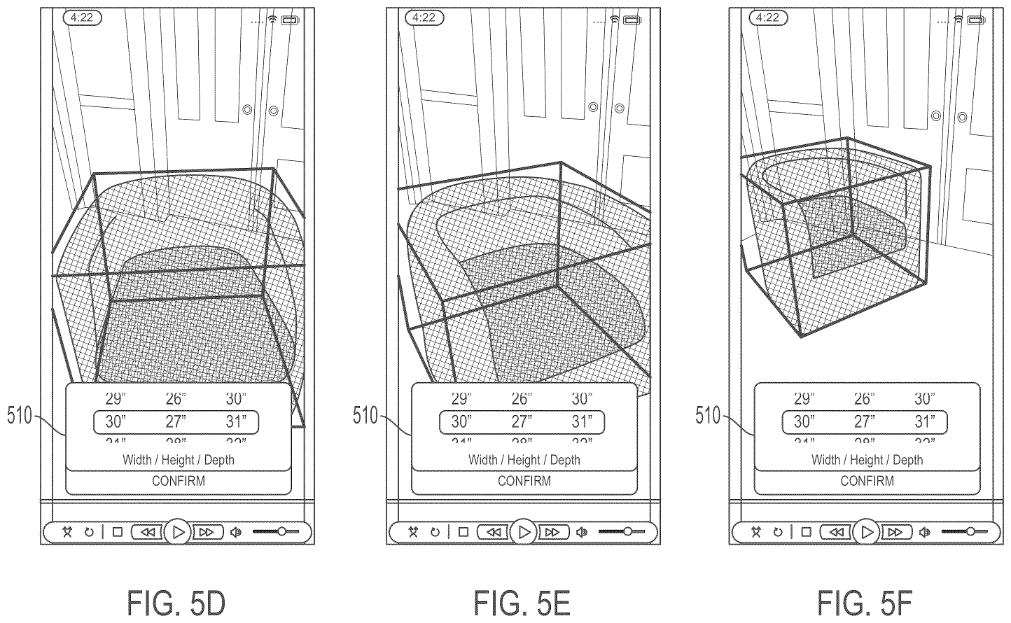

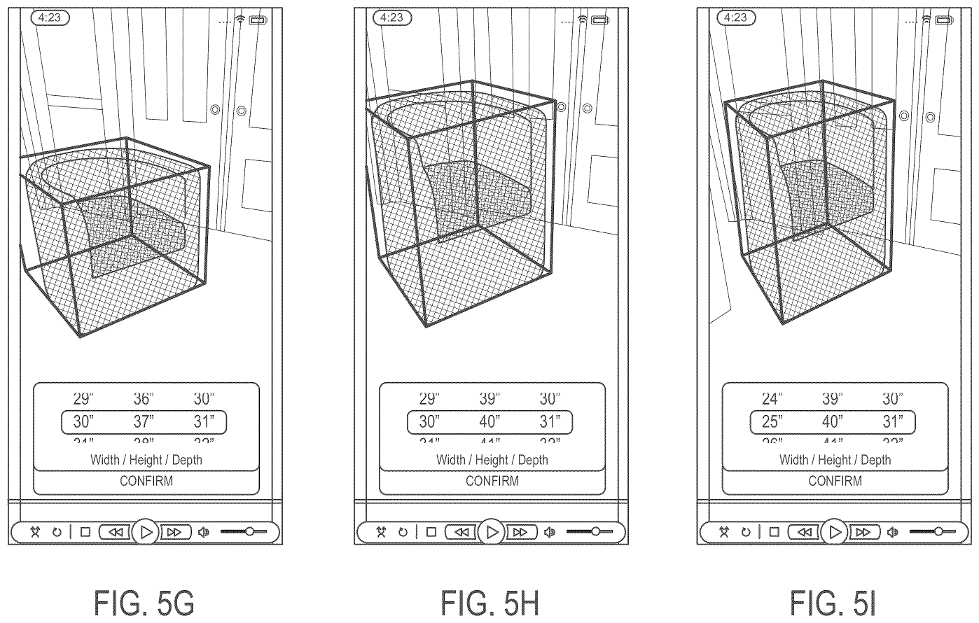

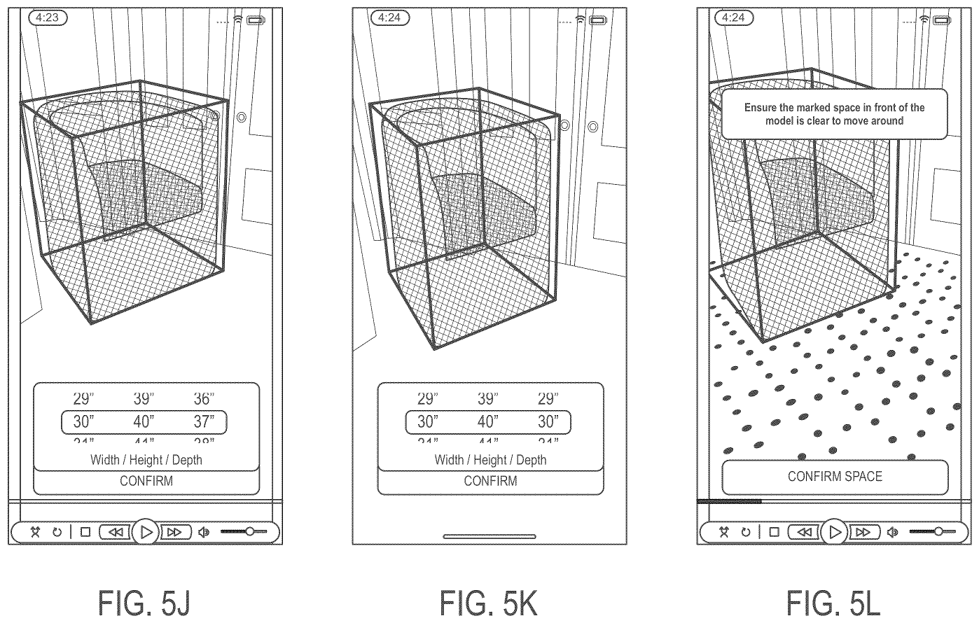

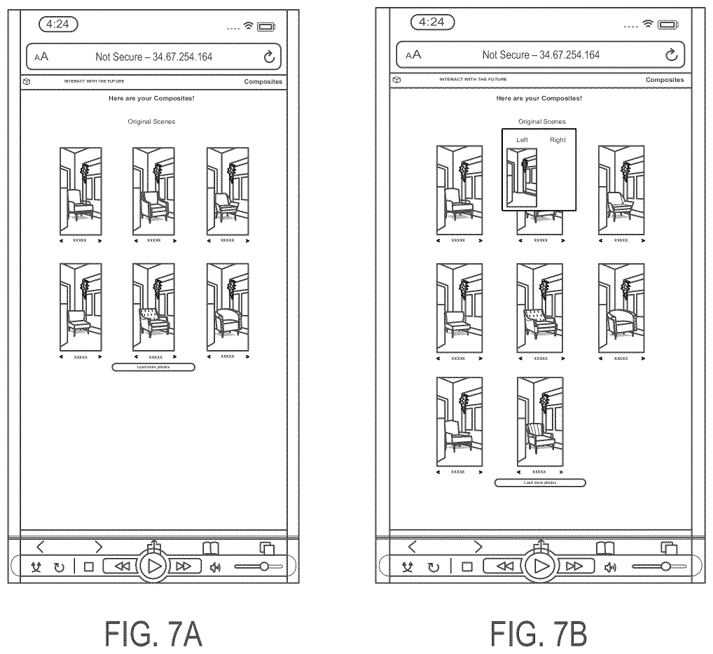

As an example, a user may provide input to the AR-enabled software application executing on the user's device that the user is interested in purchasing an accent chair. The software application may then allow the user to select a proxy accent chair model (see e.g., FIG. 5C) and position it at a desired position in the user's space (e.g., the user's living room). The user may then adjust the height, width, and/or depth of the bounding box of the proxy accent chair model as a way of specifying the desired dimensions of the product; and the software application may generate a visualization of the proxy accent chair model with those dimensions. Next, the software application may guide the user to take a fixed number of (e.g., three) images of the user's space (e.g., living room) from the same number of respective angles relative to where the accent chair is to be placed when the user purchases and receives it (e.g., the position of the proxy accent chair model specified by the user using the AR-enabled software application). The software application then transmits these images, the dimensions, the selected product type (accent chair in this example) to a server. At the server, the dimensions and product type are used to select a subset of accent chairs in the catalog that satisfy the dimensional requirements and generate composite images by superimposing the images of the selected subset of accent chairs onto one or more images of the user's living room. These images are then sent back to the software application (e.g., in a webpage as a gallery of images) for viewing by the user. In this way, the user may receive a webpage having a gallery of images of different accent chairs all shown in a specified position in the user's living room (see e.g., FIGS. 7A and 7B).

As is clear from the foregoing, some embodiments of the techniques described herein involve communicating various pieces of information gathered by the mobile device to a server. For example, the mobile device may communicate information indicating a position in the user's space at which a proxy product model was placed by a user of the mobile device, information indicating dimensions of the proxy product model, and one or more images of the user's space to the server. In turn, the server may identify a plurality of candidate product images using the received information. The server may identify the candidate product images by searching a catalog of images of products of the first type to identify images of products whose dimensions are compatible with the dimensions for the proxy product model and which were taken from camera orientations compatible with camera orientations used to capture the one or more images of the user's space. The server may generate one or more product images by compositing one or more of the plurality of candidate images with at least one of the one or more images of the user's space. The server may transmit the one or more product images to the mobile device, which may be displayed by the mobile device.

In some embodiments, the AR system developed by the inventors may guide a user to take images or photos of the user's space for visualizing products that will fit in the user's space by (i) enabling the user to place, using AR, a proxy product model in at a desired position in the user's space and adjust the size and/or dimensions of the proxy product model; (ii) guiding, using AR, the user to take one or more images of the user's space from different angles, and (iii) generating and presenting product images of different products that may fit the user's space.

The user's space may be an indoor space inside of a property, such as a room or hallway, or an outdoor space outside the property, such as a yard or porch. For example, a space in a home may be a front yard, a back yard, a side yard, a porch, a garage, a living room, a bedroom, a kitchen, a bathroom, a dining room, a family room, a basement, an attic, a closet, a laundry room, a foyer, a hallway, and/or a mud room. A space may have means of ingress and/or egress for entering and/or exiting the space. Such means may include doors, doorways, windows, etc. A property may be any suitable type of property into which furnishings, appliances, fixtures, and/or fittings may be placed. For example, a property may be a home, an apartment, an office building, a restaurant, a hotel, a store, a shopping center, and/or any other property with furnishings, appliances, and/or fixtures and fittings. In some embodiments, a property may include one building (e.g., a single-family home) or multiple buildings (e.g., multiple homes on one plot of land). In some embodiments, a property may be part of one building (e.g., an apartment in an apartment building, a store in a shopping mall, a restaurant occupying a floor of a building, an office for a company occupying one or more floors, or a part of a floor, in a building, etc.). In some embodiments, a property may include one or more buildings under shared corporate ownership or franchising agreements. In some embodiments, a home may include a single family detached house, an apartment, a bungalow, a cabin, a condominium, a townhome, a villa, a mobile home, or any other type of home.

Different types of products may be visualized in the context of one or more user's spaces using the techniques described herein. Such products may include furnishings, such as, furniture, wall coverings, window treatments, floor coverings, fixtures, and fittings, and/or other decorative accessories. Products may include appliances in the space (e.g., kitchen appliances (e.g., stove, oven, refrigerator, etc.), laundry appliances (e.g., washer, dryer, etc.), and/or other appliances). Wall coverings may include wall tiles, wallpaper, wall art, wall paint, etc. Window treatments may include curtains, shades, curtain hardware (e.g., curtain rods), and/or other treatments. Floor coverings may include flooring tiles, carpets, hardwood flooring, rugs, etc. Fixtures and fittings may include items that are integrated with or attached to the property (e.g., light fixtures, built-in furniture, existing/installed cabinetry (e.g., bath or kitchen cabinetry), sink, toilet, fireplace, mountable shelving, etc.) and items that are not attached to the property (e.g., free-standing appliances (a microwave or air fryer), rugs, etc.).

Some embodiments described herein address all the above-described issues that the inventors have recognized with conventional techniques of generating visualizations of products in AR scenes. However, it should be appreciated that not every embodiment described herein addresses every one of these issues. It should also be appreciated that embodiments of the technology described herein may be used for purposes other than addressing the above-discussed issues of conventional techniques.

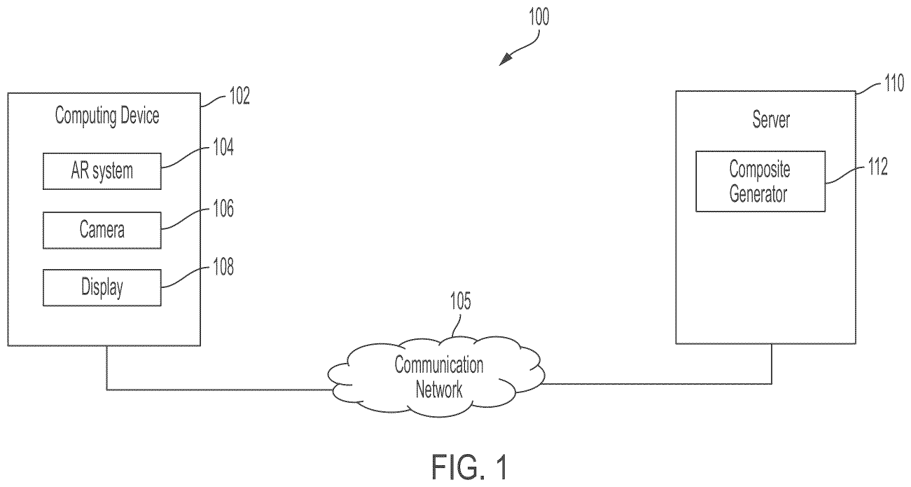

FIG. 1 is a block diagram of an example system 100 in which some embodiments of the technology described herein may be implemented. The system includes a computing device 102 in communication with at least one computer 110, such as a server, over a communication network 105.

The computing device 102 may be any computing device. In some embodiments, the computing device 102 may comprise a mobile computing device. For example, the computing device 102 may be a smartphone, tablet, laptop, or other mobile computing device. In some embodiments, the computing device 102 may comprise an augmented reality (AR) device. For example, the computing device 102 may be a set of smart glasses, a smart watch, a holographic display, or other AR device. Some embodiments are not limited to computing devices described herein.

As shown in the example of FIG. 1, the computing device 102 includes an augmented reality (AR) system 104. The AR system 104 may include a software platform installed in the computing device 102 that is configured to generate an AR scene. The AR system 104 may include one or more application programming interfaces (API(s)) that can be used to generate augmented reality. The computing device 102 may use the API(s) to generate AR scenes in applications of the computing device 102. For example, a software application installed on the computing device 102 may use the AR system 104 to generate an AR scene, and provide an AR interface through which a user may place products in the AR scene.

Examples of AR system 104 may include Apple's ARKit for iOS, or Google's ARCore for Android, or any other AR system. A software application may use the AR system 104 to generate an AR scene. The AR system 104 may enable a user to place virtual objects in an AR scene. The AR system 104 may be configured to superimpose the virtual objects on a view of a physical scene included in the AR scene. For example, an application installed on the computing device 102 may use the AR system 104 to generate an AR scene from a physical scene (e.g., captured by camera 106 coupled to the computing device 102). The software application may enable a user to place a product model (e.g., a model of furniture) in the AR scene. In some embodiments, the software application may enable the user can provide indications about characteristics of the physical scene. For example, the AR system may include an interface through which a user may indicate dimensions of a space in the physical scene that the user wishes to furnish, indicate dimensions of a desired product, indicate one or more light sources in the physical scene, and/or other information.

As shown in the example of FIG. 1, the computing device 102 includes a camera 106. In some embodiments, the camera 106 may be integrated with the computing device 102. For example, the computing device 102 may be a smartphone and the camera 106 may be a digital camera integrated in the smartphone. In some embodiments, the camera may be removably attached to the computing device 102. For example, the computing device 102 may be a laptop computer and the camera may be a digital camera that is removably attached to the laptop computer. Although the example of FIG. 1 shows the camera 106 as a component of the computing device 102, in some embodiments, the camera 106 may be separate from the computing device 102. For example, the camera 106 may be a camera attached to a wearable component (e.g., a headpiece), where images captured by the camera 106 are transmitted to the computing device 102.

In some embodiments, the camera 106 may be used by the AR system 104 to generate an AR scene. The camera 106 may capture an image of a physical scene which may be used by the AR system 104 to generate an AR scene. For example, the AR system 104 may generate an augmented reality from an image or video feed of a physical scene captured by the camera 106. In some embodiments, the camera 106 may be used by the AR system 104 to determine physical scene information. For example, the camera 106 may be used by the AR system 104 to estimate lighting in a physical scene (e.g., using imaging sensors of the camera). In some embodiments, the AR system 104 may be configured to determine values for one or more camera settings used to capture the physical scene. In some embodiments, AR system 104 may be configured to determine values for height, positions and/or orientations, camera exposure offset, vertical field of view, and horizontal field of view of the camera 106 (e.g., when used to capture an image of a space in the physical scene and/or a proxy product model of a desired product).

As shown in the example of FIG. 1, the computing device 102 includes a display 108. The display 108 may be configured to show augmented reality generated by the computing device 102 (e.g., by AR system 104). In some embodiments, the display 108 may be a display of a mobile computing device. For example, the display may be a smartphone or tablet display. In some embodiments, the display 108 may be a touch screen. A user may interact with an AR scene shown on the display 108 through the touch screen. For example, the user may indicate dimensions of the space that the user wishes to furnish and/or dimensions of a proxy product model of a desired product by selecting the dimensions within an AR scene shown on the display 108. In some embodiments, the display 108 may be a display generated by an AR device. For example, the display 108 may be an AR display shown on smart glasses.

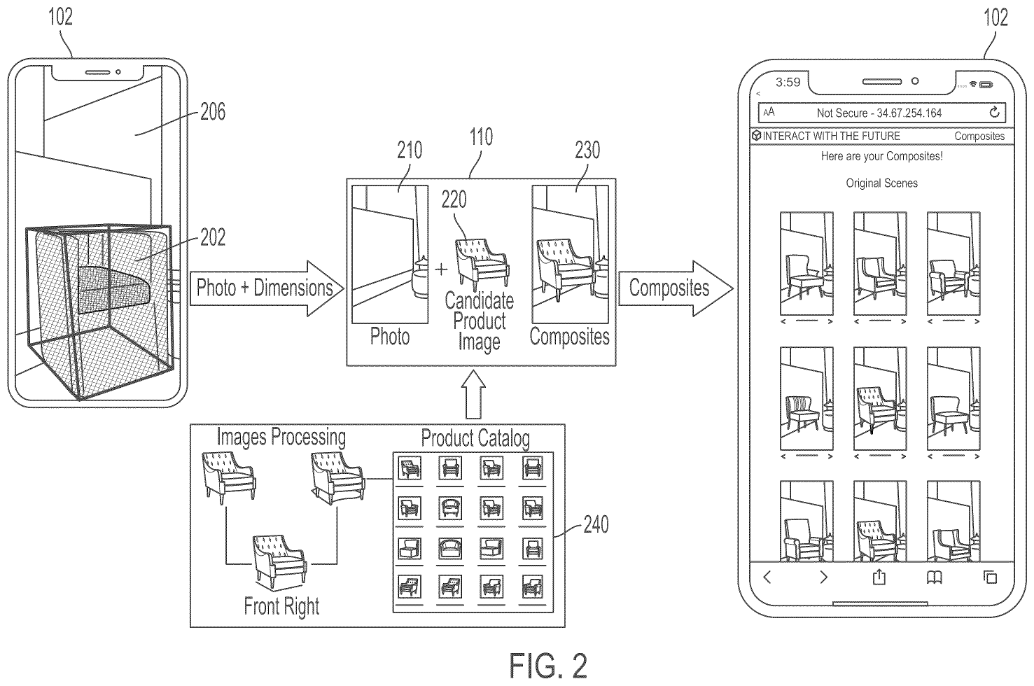

In some embodiments, the user may provide input to an AR-enabled software application indicating a selection of a first type of product (e.g., an accent chair). The software application may identify a proxy product model, such as proxy product model 202 based on the selection. The proxy product model 202 may serve as a proxy for the first type of product. In some embodiments, information indicating a position in a user's space 206 at which to place the proxy product model may be received using AR. The position may be specified as coordinates in a coordinate system. A visualization of the proxy product model 202 as shown in FIG. 2 may be generated using AR. In some embodiments, a user may indicate dimensions of the user's space and/or dimensions of the proxy product model 202. In some embodiments, the dimensions information may be received using AR. In some embodiments, the dimensions may be received without using AR, such as in the form of three-dimensional (3D) dimensions obtained via a 3D scan of the space.

In some embodiments, a user may be guided to capture image(s) of the user's space at one or more camera positions and/or orientations relative to the indicated position in the user's space. For example, visual indicator(s) for the camera position(s) and/or orientation(s) may be displayed using AR to guide the user to capture image(s) at those position(s) and/or orientation(s).

In some embodiments, the mobile device 102 may send, via at least one communication network 105 to the server 110, (1) the information indicating the position in the user's space at which to place a proxy product model, (2) the information indicating the dimensions for the proxy product model, and (3) the one or more images of the user's space, such as image 210 shown in FIG. 2. The server 110 may identify, based on the received information, a number of candidate product images, such as image 220 shown in FIG. 2, from a retailer's product catalog that includes various images of the first type of product (e.g., images of multiple different products of the first type, such as accent chair). In some embodiments, the server 110 may search the catalog to identify images of products whose dimensions are compatible with the dimensions for the proxy product model and which were taken from camera orientations compatible with camera orientations used to capture the one or more images of the user's space. The server 110 may generate one or more product images (also referred to herein as “composites” 230) by compositing one or more of the candidate product images with at least one of the one or more images of the user's space. The server 110 may transmit the one or more composites to the mobile device 102 via the at least one communication network 105.

The server 110 of FIG. 1 or 2 may comprise one or more computing devices (e.g., one or multiple servers). Server 110 may be configured to host one or more services and/or applications on a single or multiple devices. In some embodiments, the server 110 may provide service to multiple computing devices. Although the example of FIG. 1 shows only computing device 102, the server 110 may be in communication with one or more other computing devices not shown in FIG. 1. For example, the server 110 may generate product images by compositing candidate product images with one or more images of users' spaces received from any one of several computing devices.

As shown in FIG. 1, the server 110 includes a composite generator software 112. The server 110 may be configured to use the composite generator software 112 to generate the composites 230. The composites 230 may be generated by compositing one or more of the candidate product images with at least one of the one or more images of the user's space. In some embodiments, the composite generator software 112 may filter the catalog based on the dimensions for the proxy product model. The composite generator software 112 may search the catalog to identify images of products whose dimensions are compatible with the dimensions for the proxy product model. In some embodiments, the dimensions of the product may be determined to be compatible with the dimensions of the proxy product model when all the dimensions (e.g., width, height, and depth) match or match within a particular tolerance (e.g., +/−a certain threshold value). In some embodiments, the dimensions of the product may be determined to be compatible with the dimensions of the proxy product model when the dimensions of the product are dominated by the dimensions for the proxy product model (e.g., each dimension of the product is less than or equal to the corresponding dimension of the bounding box of the proxy product model). In some embodiments, the dimensions of the product may be determined to be compatible with the dimensions of the proxy product model when the overall volume of the product is smaller than the volume of the proxy product model.

In some embodiments, the composite generator software 112 may perform further comparisons to identify candidate product images. For example, the composite generator software 112 may identify images of products which were taken from camera orientations compatible with the camera orientations used to capture the one or more images of the user's space. In some embodiments, the camera orientations may be determined to be compatible when the angles at which the images of products were taken are within a threshold tolerance and/or distance of the angles at which the images of the user's space were taken. In some embodiments, the angles may be pitch, roll, yaw or any combination of these angles. In some embodiments, the angles may be shot angles which are a function of the pitch, roll, and/or yaw angles. For example, an image of a product taken at a 45 degree shot angle may be determined to be compatible with an image of a user's space taken at a 45 degree shot angle+/−a threshold tolerance.

In some embodiments, machine learning models (e.g., neural network models) may be used to determine the camera orientations (e.g., detect the shot angles) used to capture the images of the products. In some embodiments, shot angles used to capture the images of the products may be obtained from the product catalog.

In some embodiments, images of products from the catalog whose dimensions are compatible with the dimensions for the proxy product model and which were taken from camera orientations compatible with the camera orientations used to capture the one or more images of the user's space are identified as candidate product images. In some embodiments, for these candidate product images, the composite generator software 112 may scale the candidate product images to produce true to scale visualizations. The composite generator software 112 may, for each candidate product image, calculate pixel to inch ratio of the candidate product image and the compatible image of the user's space/proxy product model to produce a true to scale visualization. For example, a determination regarding how many pixels in each image scale to a number of inches of width, height, and length on a per-product basis may be made.

In some embodiments, the candidate product images may be composited onto the image of the user's space and the resulting composites may be transmitted to the mobile device 102. In some embodiments, the candidate product images are visualized at true to scale in all the composites shown in the web page (e.g., true to original dimensions of the product being visualized as if it were physically in the space captured using AR). The scaling calculations/operations are performed for each candidate product image against each image of the user's space using the user coordinates and information received from the mobile device (e.g., using AR) once they meet the dimensional criteria/compatibility referenced.

In some embodiments, the images described herein, for example, processed images, candidate images, product images, etc., may be generated using the techniques described in U.S. Published Patent Application US2022/0084296 entitled “Techniques for Virtual Visualization of a Product in a Physical Scene,” the entire contents of which are incorporated by reference herein.

In some embodiments, the mobile device 102 may obtain the composites of the first product type from the server 110 and display the composites via a non-AR interface. For example, the composites may be displayed via a webpage having the composites embedded therein. In some embodiments, the webpage may be generated at the server 110 and communicated to the mobile device 102 for display. In some embodiments, the webpage may be refreshed or updated with new composites at predetermined intervals (e.g., every 2-10 seconds or any other suitable interval) to support infinite scrolling that enables browsing for product matches as the user scrolls down the webpage, where the product matches shown are true to scale and will fit in the user's space.

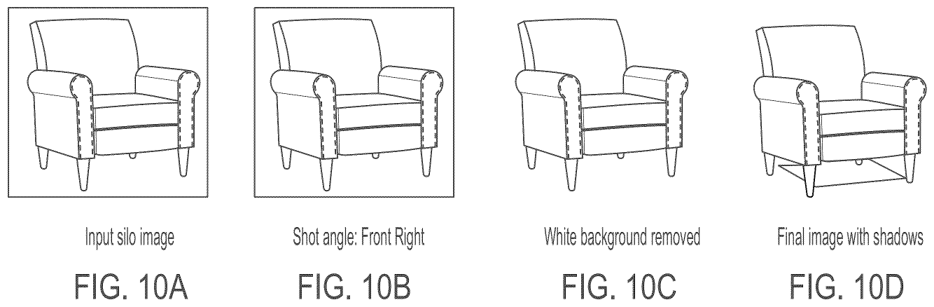

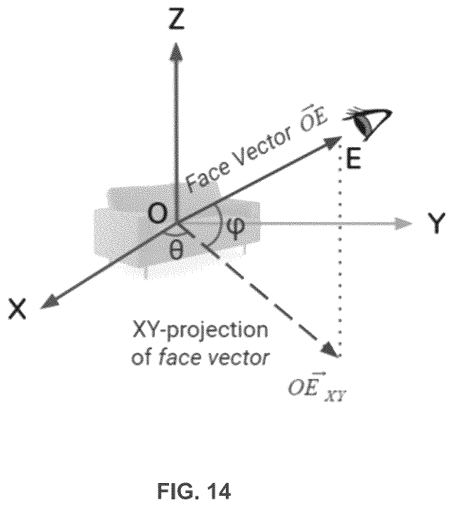

In some embodiments, the catalog 240 of images of products that is utilized to identify candidate product images may be stored at the server 110. Each product image in the catalog may comprise a processed product silo or lifestyle image used for creating the composite images rendered on webpage. An overview of the processing is shown in FIGS. 10A-10D. In some embodiments, the processing of a product silo or lifestyle image may include running it through a machine learning model (e.g., a regression-based machine learning model) that detects the angle the product is facing in the image, also referred to herein as the shot angle of the product, and labels it. The shot angle is an angle between the face of a product and a (virtual) camera taking that image. The shot angle may be the azimuth or horizontal angle θ in FIG. 14. In FIG. 14, face vector OE may be a vector between the front face of the product and the virtual observer, an elevation or vertical angle φ may be an angle made by face vector OE with the XY plane, and the azimuth or horizontal angle θ may be an angle made by XY projection of the face vector OE, i.e., OE_{XY} with X axis.

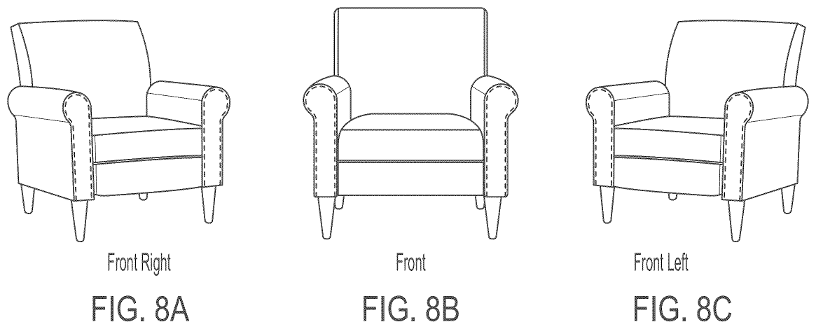

In some embodiments, the machine learning model may predict the shot angle (e.g., floating point value), which is then assigned to a categorical zone label according to a custom-defined range the angle value falls into, as shown in FIG. 10B. In some embodiments, the predicted shot angle of the product may be assigned to a categorical zone label, such as, “Front Right”, “Front”, or “Front Left” as shown in FIGS. 8A-8C. A predicted shot angle may be assigned the zone label “Front Right” when the angle the product is facing is between 7 degrees to 80 degrees. A predicted shot angle may be assigned the zone label “Front” when the angle the product is facing is between 7 degrees to −7 degrees. A predicted shot angle may be assigned a zone label “Front Left” when the angle the product is facing is between −7 degrees to 80 degrees. For example, if the machine learning model outputs a predicted shot angle of the product as 52 degrees, this shot angle is assigned the label “Front Right” as it lies within the range 7 degrees to degrees. Other categorical zone labels and ranges for the labels may be used as aspects of the disclosure are not limited in this respect. For example, shot angle ranges for the “Front Right” label may be 15 degrees to 75 degrees, the “Front” label may be 0 degrees to 15 degrees and 345 degrees to 360 degrees, and the “Front Left” label may be 285 degrees to 345 degrees.

In some embodiments, shot angle detection or prediction may be performed using machine learning models (e.g., deep learning models based on the VGG network described in Simonyan et. al., “Very Deep Convolutional Networks for Large-Scale Image Recognition,” Computer Vision and Pattern Recognition, arXiv:1409.1556, April 2015, which is incorporated by reference herein in its entirety).

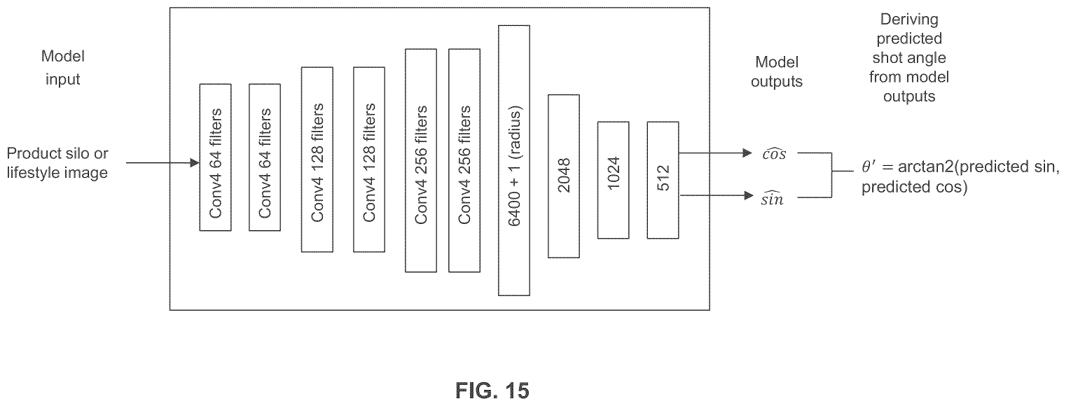

In an example implementation, shot angle detection or prediction was performed using a deep learning model having the architecture shown in FIG. 15. During a training phase, the model was trained using labeled data (e.g., images labeled by human annotators). For each input image (e.g., an image of a product), a corresponding label is the sin and cos of the shot angle of the product. The labels for various images used for training the model were derived from inputs from human annotators indicating respective zones that best represent the images.

During the inference stage (i.e., after the model has been sufficiently trained), the model takes as input a single image (e.g., a silo or lifestyle image) and predicts the shot angle of the product in the image. The output is in the form of the sin and cos of the shot angle. The predicted shot angle θ′ may be derived from the predicted sin and cos outputs.

In some embodiments, a custom loss function using the Mean Square Error (MSE) or square differences was defined as shown below.

loss=MSE (cos label)+MSE (sin label)=(cos θ−predicted cos)2+(sin θ−predicted sin)2, where cos θ and sin θ represent the shot angle label used during the training phase.

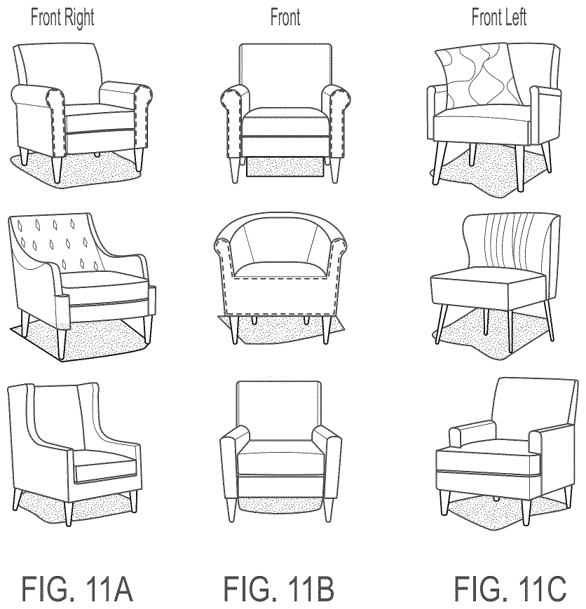

In some embodiments, the processing may include removing the white background or lifestyle background (e.g., making it transparent as shown in FIG. 10C) from the images using machine learning models trained to segment background pixels from foreground pixels (e.g., deep learning models for image segmentation including, for example, deep learning models described in Chen et. al., “Encoder-Decoder with Atrous Separable Convolution for Semantic Image Segmentation,” Computer Vision and Pattern Recognition, arXiv:1802.02611, August 2018, which is incorporated by reference herein in its entirety) and adding shadows using image processing or computer vision techniques to create a photorealistic look. For example, static images of shadows may be added to the product images through compositing as shown in FIG. This processing produces a set of candidate product images (shown in FIGS. 11A-11C, for example), where each candidate product image is set against a transparent background with shadows and with the shot angle at which the image was taken identified. This set of candidate product images may be stored on the server 110. In some embodiments, the processed images may be generated offline or at some point in time prior to the generation of composites.

In some embodiments, a shadow may be added to a product image by first generating a gray rectangle which is skewed by 0 degrees, 10 degrees or −10 degrees depending on the shot angle of the product and then adding a random number (e.g., between 2-5 or any other suitable number or range) of gray ellipses that are each rotated by a random value. This is then composited with the transparent images (i.e., background subtracted/removed images) using alpha blending to render the set of product images shown in FIGS. 11A-11C, for example.

In some embodiments, the communication network 105 of FIG. 1 may be the Internet, a local area network, a wide area network, and/or any other suitable communication network. Aspects of the technology described herein are not limited in this respect.

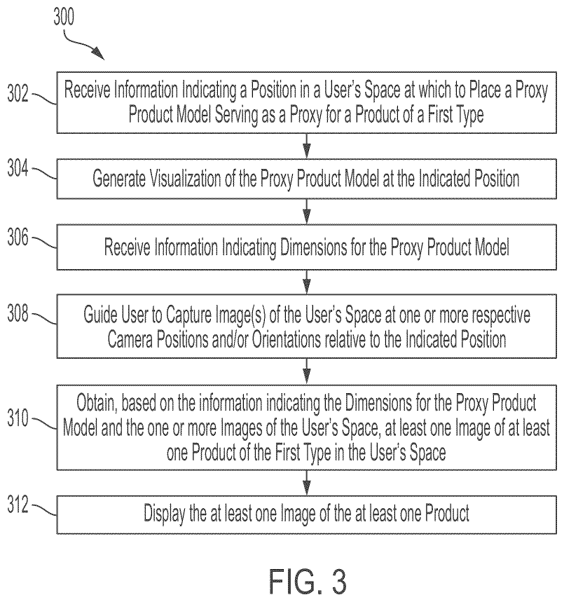

FIG. 3 shows a flowchart of an example process 300 for generating product images in a user's space, according to some embodiments of the technology described herein. Process 300 may be performed by any suitable computing device. For example, process 300 may be performed by mobile device 102 described above with reference to FIGS. 1-2.

Process 300 begins at block 302, where the system performing process 300 receives information indicating a position in a user's space at which to place a proxy product model serving as a proxy for a product of a first type. This information may be received by mobile device 102 having camera 106. In some embodiments, this information may be received using AR. In some embodiments, user input indicating a selection of the first type of product (e.g., accent chair) may be received and the proxy product model may be identified based on the selection of the first type of product (e.g., using AR). In some embodiments, user input indicating the selection may be received via a menu listing different types of products, or other graphical element enabling selection using AR.

In some embodiments, the system may prompt the user to move the mobile device to detect a surface in the user's space, where the surface is near the indicated position in the user's space. The surface may be a horizontal surface (e.g., flooring surface or furniture surface) or an upright surface (e.g., wall surface or furniture surface). A screenshot of such a prompt being displayed using AR is shown in FIG. 5A. In some embodiments, the system may prompt the user to place the proxy product model in the user's space. A screenshot of such a prompt being displayed using AR is shown in FIG. 5B. In some embodiments, the user may interact with visual indicator(s), such as visual indicator 502, displayed using AR to indicate a position in the user's space at which to place the proxy product model. For example, the user may tap on indicator 502 to indicate the position.

At block 304, the system performing process 300 generates a visualization of the proxy product model at the indicated position. The system may generate the visualization of the proxy product model positioned on the detected surface. A screenshot of a visualization of the proxy product model 504 displayed using AR is shown in FIG. 5C.

At block 306, the system performing process 300 receives, using AR, information indicating dimensions for the proxy product model. In some embodiments, information indicating width, height, and/or depth of a bounding box of the proxy product model may be received. Screenshots of a user indicating dimensions for the proxy product model are shown in FIGS. 5C-5K. As shown in FIGS. 5C-5K, a user may interact with a scrollable list 510 that allows the user to scroll through and select the dimensions for the proxy product model. In some embodiments, the system may prompt the user to confirm the selected dimensions and space. For example, a user may confirm dimensions by selecting “Confirm” in FIG. 5K. A screenshot of a prompt, shown in FIG. 5L, enables the user to ensure that a marked space (e.g., a particular area around or in front of the proxy product model)—indicated by a dotted pattern on the surface—is clear to move around and confirm the space (for example, by clicking “Confirm Space”).

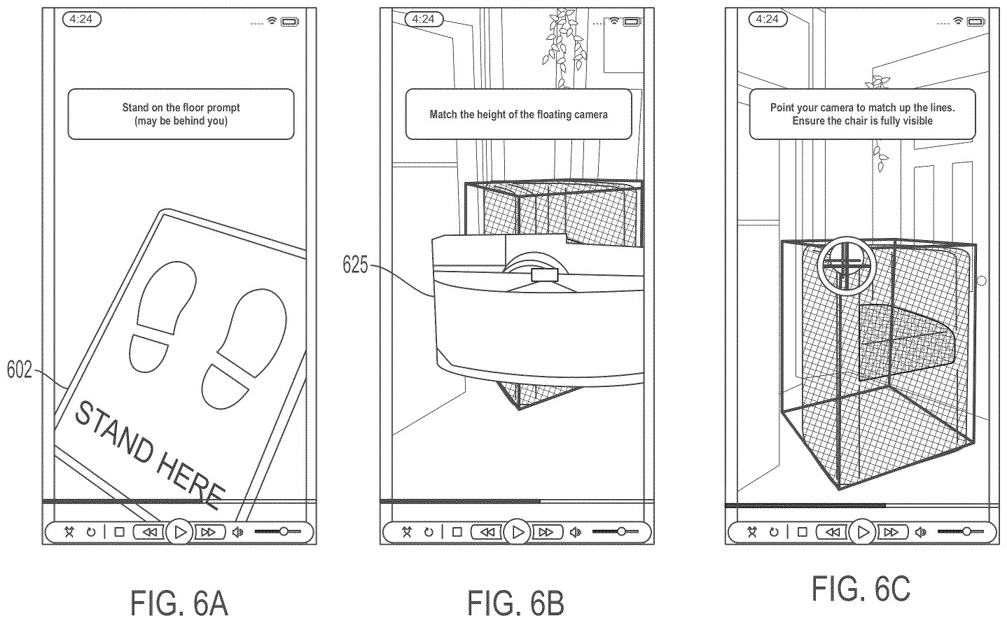

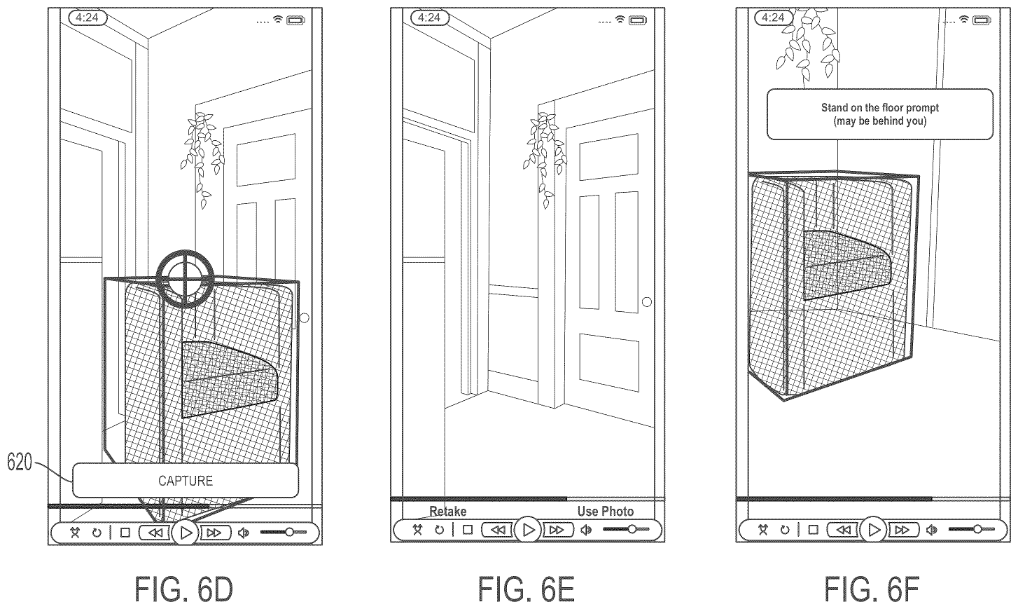

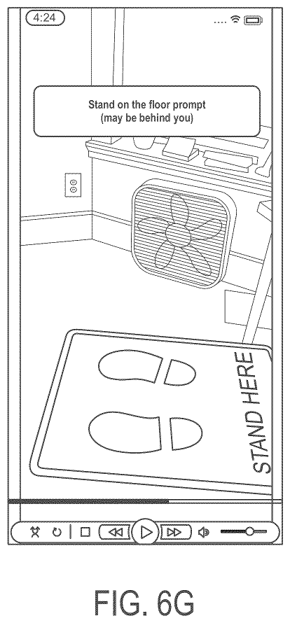

At block 308, the system performing process 300 guides, using AR, the user to capture one or more images of the user's space at one or more respective camera positions and/or orientations relative to the indicated position, in the user's space. In some embodiments, the system may guide the user to capture a first image of the user's space by guiding the user to a first position, and guiding the user, when at the first position, to position the camera at a first height and orient the camera of the mobile device in a first orientation, as shown in FIGS. 6A-6D. In some embodiments, the system may guide the user to the first position by displaying a visual indicator, such as a floor prompt indicator 602 for the position, to the user using AR. In some embodiments, the system may guide the user to orient the camera in the first orientation by guiding the user, using AR, to orient the camera to have a pitch, roll, and/or yaw angle, each of which is a specified value or any value occurring within a specified range of values, as shown in FIGS. 6B-6C. In some embodiments, the user may capture an image of the user's space at a respective camera position and/or orientation by selecting “Capture” 620 in FIG. 6D.

In some embodiments, the height of the camera may be calculated based on the height of the proxy product model. A floating camera indicator 625 (shown in FIG. 6B) may be shown to the user at/after the “stand here” floor prompt 602 (shown in FIG. 6A) and this is followed by the cross-hair alignment for the angle-based camera parameters (e.g., camera orientations shown in FIGS. 6C and 6D).

In some embodiments, the system may guide the user to capture one or more additional images of the user's space by guiding the user to one or more additional positions, and at each particular position of the one or more additional positions, guiding the user, when at the particular position, to orient the camera of the mobile device in a specified orientation for the particular position, as shown in FIGS. 6E-6G.

In some embodiments, a user may place a proxy product model in the desired position using pan and rotate gestures available via the AR system. The height, width, and/or depth dimensions of the proxy product model may be changed using AR with minimum resolution of an inch. In some embodiments, the user may take three images or photos of the proxy product model or the user's space where the proxy product model is placed by standing on the floor prompts shown using AR. The angles at which the images are taken are chosen to match the shot angle guidelines prescribed by 3D artists while curating the product catalog. For example, FIG. 8 shows example shot angles at which the images of products were taken while curating the product catalog. The user may align the camera to meet the pitch, yaw, and roll constraints set to allow for consistent quality of scene images. The captured images or photos are communicated by the mobile device 102 to the server 110 to composite them with one or more product images in the product catalog.

At block 310, the system performing process 300 obtains, based on the information indicating the dimensions for the proxy product model and the one or more images of the user's space, at least one image of at least one product of the first type in the user's space. At block 312, the system displays the at least one image of the at least one product. In some embodiments, the system may obtain at least one webpage comprising a plurality of images of a plurality of products of the first type in the user's space, as shown in FIGS. 7A-7B.

In some embodiments, the mobile device 102 may send: (1) the information indicating the position in the user's space at which to place a proxy product model, (2) the information indicating the dimensions for the proxy product model, and (3) the one or more images of the user's space, to the server 110. The server 110 may generate the at least one image of the at least one product using this information and generate a webpage including the at least one image of the at least one product.

In some embodiments, the system enables a “Search with Space” approach to visualizing products in the user's space that starts with the user's space as input and visualizes products that will fit in the space at nearly true scale. The user may place a proxy product model in a desired position in the user's space and update the dimensions using augmented reality, capture images of the model/space from preset angles, and view a webpage (e.g., displayed as a gallery of images) curated with product matches that will fit the user's space and shown true to scale in the original photos of the user's space. This approach allows the user to set, snap, and see products that will fit in his/her space. This approach enables spatial browsing or spatial searching to obtain product matches and visualizations that fit the user's space.

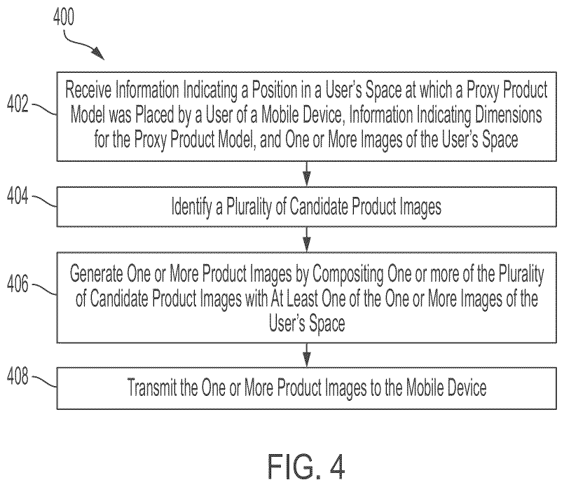

FIG. 4 shows a flowchart of an example process 400 for generating product images in a user's space, according to some embodiments of the technology described herein. Process 400 may be performed by any suitable computing device. For example, process 400 may be performed by server 110 described above with reference to FIGS. 1-2.

Process 400 begins at block 402, where the system performing process 400 receives, from a mobile device (e.g., mobile device 102), information indicating a position in a user's space at which a proxy product model was placed by a user of the mobile device, information indicating dimensions for the proxy product model, and one or more images of the user's space.

At block 404, the system performing process 400 identifies a plurality of candidate product images. The system may search a catalog of images of products of the first type to identify images of products whose dimensions are compatible with the dimensions for the proxy product model and which were taken from camera orientations compatible with camera orientations used to capture the one or more images of the user's space.

At block 406, the system performing process 400 generates one or more product images by compositing one or more of the plurality of candidate images with at least one of the one or more images of the user's space. At block 408, the system performing process 400 transmits, to the mobile device, the one or more product images.

In some embodiments, the system enables a “Search with Space” approach to visualizing products in the user's space that enables a user to select a desired position in and dimensions of the space they would like to furnish by using augmented reality. Using the spatial information and user photos, a catalog may be filtered for products that will physically fit and a gallery page of results may be rendered. The gallery page results showcase the user's space with individual products composited at nearly true to scale. The user may browse the page for products that match their design sensibilities, share it for asynchronous collaboration on a design project, or re-start the process with different design criteria. “Search with space” inverts the typical user journey of navigating to individual product pages, one at a time, and visualizing products for their space; instead, this approach enables a user to start with his/her space and collate all product matches for the space to compare, review, and decide. Other example use cases for this approach include providing scene-based shopping recommendations, providing product-based complementary recommendations, or enabling asynchronous collaboration and designer services.

In some embodiments, multiple proxy product models may be placed in a user's space and a product image obtained from the server may include more than one product in the image. In some embodiments, images of the user's space may include existing images of the user's space (e.g., home) or images obtained from third-party sources. In some embodiments, the user may initially upload images of their space to a search program so that a “category” of the space may be assessed (e.g., living room, bedroom, etc.), or the user may identify the space, and thereby further limit available products for placement. In some embodiments, these images may be saved to the customer's user account. The saved or uploaded images may be assigned unique IDs and may be re-used.

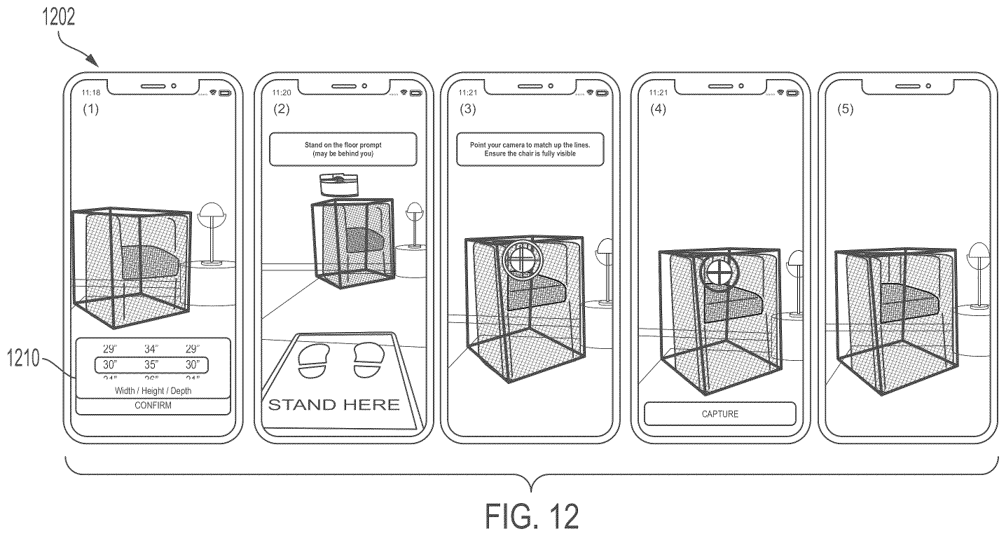

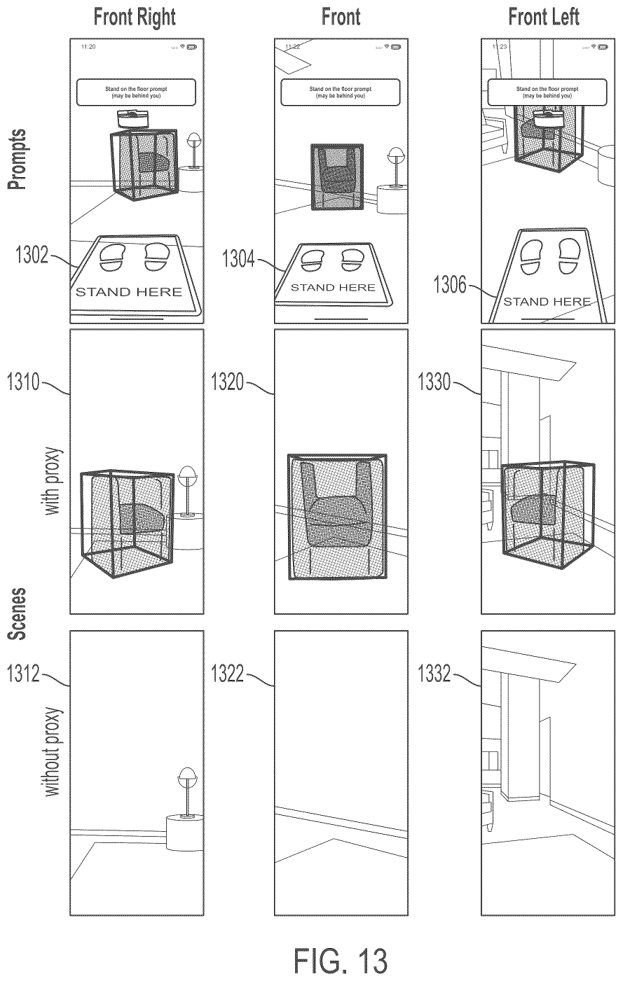

FIG. 12 illustrates an overview of an AR guided capture of a user's space, according to some embodiments of the technology described herein. The AR guided capture is performed using any suitable computing device, for example, mobile device 102 described above with reference to FIGS. 1-2. As shown in screenshot 1202, the user may indicate a position in the user's space at which to place a proxy product model and dimensions for the proxy product model. For example, the user may set the dimensions of the proxy product model using a GUI element 1210 having a scrollable list of values for each of multiple dimensions (width, height, and depth, in this example). Next, the user may be guided to capture one or more images of the user's space at one or more respective camera positions and/or orientations relative to the indicated position, in the user's space. For example, the user may be prompted to stand on a sequence of floor prompts (e.g., floor prompts 1302, 1304, 1306 as shown in FIG. 13) shown in AR. In some embodiments, the floor prompts presented may follow the same schema as the shot angle for the products discussed above with reference to FIGS. 8A-8C, i.e., “Front Right”, “Front”, and “Front left”. Subsequently, the user may align the camera at a height and orientation relative to the indicated position of the proxy product model. Guiding the user to take shots from a sequence of floor prompts that follow the same schema as the shot angles used to curate the product catalog ensures that the shot angles at which images of the user's space are captured in accordance with the guidance process match the shot angles at which images of the products were taken while curating the product catalog. Once the user selects the “Capture” button for each prompt, the system captures two images for the prompt, a first image of the user's space including the proxy product model and a second image of the user's space without the proxy product model. For example, as shown in FIG. 13, two images 1310, 1312 are captured for prompt 1302; two images 1320, 1322 are captured for prompt 1304; and two images 1330, 1332 are captured for prompt 1306. In some embodiments, the first image including the proxy product model may be used to obtain the bounding box coordinates for the proxy product model. In some embodiments, the second image without the proxy product model may be used for compositing.

For example, as shown in FIG. 13, a first floor prompt 1302 may be set to the “Front Right” of the proxy product model at an angle of 60 degrees, which is within the range of the zone label from shot angle, “Front Right”, defined for the product images. The user may be prompted to capture the “Front Right” image of the user's space once the camera alignment is complete. Similarly, the user may be prompted two additional times (e.g., via floor prompts 1304, 1306), to capture the “Front” image of the user's space, which is a head-on shot set at 0° with respect to the proxy product model and within the −7 degrees and 7 degrees zone range for shot angle “Front”, followed by the “Front Left” image of the user's space, which is a side shot set at −60 degrees with respect to the proxy product model and within the zone range for the shot angle “Front Left”. Once images have been captured for all three angles, the captured images (e.g., the second image without the proxy product model) along with the x, y, z coordinates of the bounding box of the proxy product model in each image are sent to the server for compositing the results.

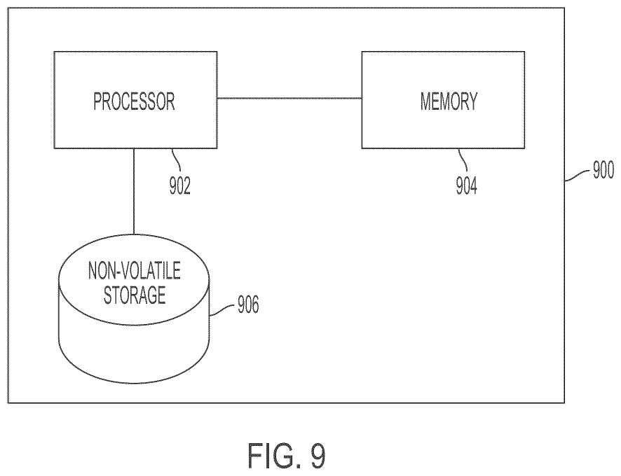

FIG. 9 shows a block diagram of an example computer system 900 that may be used to implement embodiments of the technology described herein. The computing device 900 may include one or more computer hardware processors 902 and non-transitory computer-readable storage media (e.g., memory 904 and one or more non-volatile storage devices 906). The processor(s) 902 may control writing data to and reading data from (1) the memory 904; and (2) the non-volatile storage device(s) 906. To perform any of the functionality described herein, the processor(s) 902 may execute one or more processor-executable instructions stored in one or more non-transitory computer-readable storage media (e.g., the memory 904), which may serve as non-transitory computer-readable storage media storing processor-executable instructions for execution by the processor(s) 902.

The computer system 900 may be a portable computing device (e.g., a smartphone, a tablet computer, a laptop, or any other mobile device), a computer (e.g., a desktop, a rack-mounted computer, a server, etc.), or any other type of computing device.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method for generating product images in a user's space, the method comprising:
using at least one computer hardware processor to perform:
receiving, by a mobile device having a camera, information indicating a position in the user's space at which to place a proxy product model serving as a proxy for a product of a first type;
generating, using augmented reality (AR), a visualization of the proxy product model, at the indicated position, in the user's space;
receiving information indicating dimensions for the proxy product model;
guiding, using AR, the user to capture one or more images of the user's space, with the mobile device, at one or more respective camera positions and/or orientations relative to the indicated position, in the user's space;
obtaining, based on the information indicating the dimensions for the proxy product model and the one or more images of the user's space, at least one image of at least one product of the first type in the user's space; and
displaying the at least one image of the at least one product.

2. The method of claim 1, further comprising:
detecting a surface in the user's space, wherein the surface is near the indicated position in the user's space,
wherein generating the visualization of the proxy product model comprises generating the visualization of the proxy product model positioned on the surface.

3. The method of claim 2, wherein the surface is a horizontal surface or an upright surface.

4. The method of claim 1, further comprising:
receiving user input indicating a selection of the first type of product; and
identifying the proxy product model based on the selection of the first type of product.

5. The method of claim 1, wherein receiving the information indicating dimensions for the proxy product model comprises receiving information indicating width, height, and/or depth of a bounding box of the proxy product model.

6. The method of claim 1, wherein the guiding comprises:
guiding the user to capture a first image of the user's space by:
guiding the user to be at a first position, and
guiding the user, when at the first position, to position the camera at a first height and to orient the camera of the mobile device in a first orientation.

7. The method of claim 6, wherein guiding the user to the first position comprises displaying a visual indicator for the position to the user using AR.

8. The method of claim 7, wherein displaying the visual indicator comprises displaying the visual indicator on a surface on which the user is to stand.

9. The method of claim 6, wherein guiding the user to orient the camera in the first orientation comprises guiding the user, using AR, to orient the camera to have a pitch, roll, and/or yaw angle, each of which is a specified value or any value occurring within a specified range of values.

10. The method of claim 6, wherein the guiding further comprises:
guiding the user to capture one or more additional images of the user's space by:
guiding the user to one or more additional positions, and
at each particular position of the one or more additional positions, guiding the user, when at the particular position, to orient the camera of the mobile device in a specified orientation for the particular position.

11. The method of claim 1, wherein obtaining the at least one image of a product of the first type in the user's space comprises:
sending, from the mobile device via at least one communication network to at least one computer, (1) the information indicating the position in the user's space at which to place a proxy product model, (2) the information indicating the dimensions for the proxy product model, and (3) the one or more images of the user's space; and
receiving, by the mobile device via the at least one communication network from the at least one computer, the at least one image of the at least one product of the first type in the user's space.

12. The method of claim 1, wherein obtaining the at least one image of the at least one product of the first type in the user's space comprises:
identifying a plurality of candidate product images, the identifying comprising searching a catalog of images of products of the first type to identify images of products whose dimensions are compatible with the dimensions for the proxy product model and which were taken from camera orientations compatible with the camera orientations used to capture the one or more images of the user's space; and
generating one or more product images by compositing one or more of the plurality of candidate product images with at least one of the one or more images of the user's space.

13. The method of claim 12, wherein the identifying comprises searching the catalog of images of products of the first type to identifying images of products whose dimensions are dominated by the dimensions for the proxy product model.

14. The method of claim 1, wherein obtaining the at least one image of the at least one product of the first type in the user's space comprises:
obtaining a plurality of images of a plurality of products of the first type in the user's space.

15. The method of claim 14, wherein obtaining the plurality of images comprises:
obtaining at least one webpage comprising the plurality of images.

16. The method of claim 1, wherein the at least one product of the first type comprises an article of furniture, a fixture, an appliance, art, flooring, or wallpaper.

17. A mobile device, comprising:
at least one camera;
at least one computer hardware processor;
at least one non-transitory computer-readable storage medium storing processor-executable instructions that, when executed by the at least one computer hardware processor, cause the at least one computer hardware processor to perform a method comprising:
receiving information indicating a position in a user's space at which to place a proxy product model serving as a proxy for a product of a first type;
generating, using augmented reality (AR), a visualization of the proxy product model, at the indicated position, in the user's space;
receiving information indicating dimensions for the proxy product model;
guiding, using AR, the user to capture one or more images of the user's space, with the mobile device, at one or more respective camera positions and/or orientations relative to the indicated position, in the user's space;
obtaining, based on the information indicating the dimensions for the proxy product model and the one or more images of the user's space, at least one image of at least one product of the first type in the user's space; and
displaying the at least one image of the at least one product.

18. At least one non-transitory computer-readable storage medium storing processor-executable instructions that, when executed by at least one computer hardware processor of a mobile device, cause the at least one computer hardware processor to perform a method comprising:
receiving, by the mobile device having a camera, information indicating a position in the user's space at which to place a proxy product model serving as a proxy for a product of a first type;
generating, using augmented reality (AR), a visualization of the proxy product model, at the indicated position, in the user's space;
receiving information indicating dimensions for the proxy product model;
guiding, using AR, the user to capture one or more images of the user's space, with the mobile device, at one or more respective camera positions and/or orientations relative to the indicated position, in the user's space;
obtaining, based on the information indicating the dimensions for the proxy product model and the one or more images of the user's space, at least one image of at least one product of the first type in the user's space; and
displaying the at least one image of the at least one product.

19. A method for generating product images in a user's space, the method comprising:
using at least one computer hardware processor to perform:
receiving, from a mobile device and via at least one communication network,
information indicating a position in the user's space at which a proxy product model was placed by a user of the mobile device, wherein the proxy product model is a proxy for a product of a first type;
information indicating dimensions for the proxy product model, and
one or more images of the user's space;
identifying a plurality of candidate product images, the identifying comprising searching a catalog of images of products of the first type to identify images of products whose dimensions are compatible with the dimensions for the proxy product model and which were taken from camera orientations compatible with camera orientations used to capture the one or more images of the user's space;
generating one or more product images by compositing one or more of the plurality of candidate images with at least one of the one or more images of the user's space; and
transmitting, to the mobile device and via the at least one communication network, the one or more product images.

20. The method of claim 19,
wherein the one or more images of the user's space comprise a first user space image taken at a first camera orientation,
wherein the plurality of candidate product images comprises a first candidate product image taken with a camera having an orientation compatible with the first camera orientation,
and wherein the compositing comprises compositing the first user space image with the first candidate product image.

21. The method of claim 19, wherein the receiving the one or more images of the user's space comprises receiving information indicating the camera orientations used to capture the one or more images of the user's space.

22. The method of claim 19, further comprising:
using a neural network model to determine the camera orientations used to capture the one or more images of the user's space.

23. The method of claim 19, wherein generating the one or more product images comprises generating at least one webpage comprising the plurality of images.

24. At least one computer comprising:
at least one computer hardware processor; and
at least one non-transitory computer-readable storage medium storing processor executable instructions that, when executed by the at least one computer hardware processor, cause the at least one computer hardware processor to perform a method comprising:
receiving, from a mobile device and via at least one communication network,
information indicating a position in a user's space at which a proxy product model was placed by a user of the mobile device, wherein the proxy product model is a proxy for a product of a first type;
information indicating dimensions for the proxy product model, and
one or more images of the user's space;
identifying a plurality of candidate product images, the identifying comprising searching a catalog of images of products of the first type to identify images of products whose dimensions are compatible with the dimensions for the proxy product model and which were taken from camera orientations compatible with camera orientations used to capture the one or more images of the user's space;
generating one or more product images by compositing one or more of the plurality of candidate images with at least one of the one or more images of the user's space; and
transmitting, to the mobile device and via the at least one communication network, the one or more product images.

25. At least one non-transitory computer-readable storage medium storing processor executable instructions that, when executed by at least one computer hardware processor, cause the at least one computer hardware processor to perform a method comprising:
receiving, from a mobile device and via at least one communication network,
information indicating a position in a user's space at which a proxy product model was placed by a user of the mobile device, wherein the proxy product model is a proxy for a product of a first type;
information indicating dimensions for the proxy product model, and
one or more images of the user's space;
identifying a plurality of candidate product images, the identifying comprising searching a catalog of images of products of the first type to identify images of products whose dimensions are compatible with the dimensions for the proxy product model and which were taken from camera orientations compatible with camera orientations used to capture the one or more images of the user's space;
generating one or more product images by compositing one or more of the plurality of candidate images with at least one of the one or more images of the user's space; and
transmitting, to the mobile device and via the at least one communication network, the one or more product images.
